(19) United States
(12) Patent Application Publication
(10) Pub. No.: US 2017/0197868 A1
(43) Pub. Date: Jul. 13, 2017

(54) Laser Processing of Electronic Device Structures

(71) Applicant: Apple Inc., Cupertino, CA (US)

(72) Inventors: Nathan K. Gupta, San Francisco, CA (US); Sudirukkuge T. Jinasundera, San Jose, CA (US)

(21) Appl. No.: 15/159,067

(22) Filed: May 19, 2016

Related U.S. Application Data
(60) Provisional application No. 62/276,735, filed on Jan. 8, 2016.

(51) Int. Cl. C03B 33/09; B23K 26/0622; B23K 26/53; B23K 26/082; C03B 33/10; B23K 26/00

(52) U.S. Cl. CPC C03B 33/091; C03B 33/102; B23K 26/0057; B23K 26/53; B23K 26/082; B23K 26/0006; B23K 26/0624; B23K 2203/54

(57) ABSTRACT

Laser processing techniques may be used to form structures for electronic devices. A laser processing system may be provided with lasers and positioners for moving laser beams across a structure to be processed such as a layer of glass or other material. A laser such as a pulsed infrared laser may be move along a path across the layer of material. The laser may create a series of damaged regions along the path. A portion of the layer may be removed from other portions of the layer by breaking off the portion of the layer along the path. Laser-induced heating techniques and mechanical stress-inducing techniques may be used to impart stress to the layer of material to help break off the portion. The layer may include one or more sublayers such as layers of glass substrate material in a display.

This application claims the benefit of provisional patent application No. 62/276,735, filed Jan. 8, 2016, which is hereby incorporated by reference herein in its entirety.

### FIELD

This relates generally to electronic devices and, more particularly, to electronic devices with laser processed structures such as laser cut display layers.

### BACKGROUND

Electronic devices often contain layers of material that that have been cut from larger pieces of material. For example, electronic device displays may be formed by cutting individual display panels from large mother glass panels.

It can be challenging to cut brittle materials such as the layers of glass in a display. In some situations, mechanical scribing and breaking operations and grinding operations are used. In other situations, a carbon dioxide laser is used to create a stress line across a glass layer that allows the glass layer to be broken in a desired location. Difficulties arise when using these techniques to create complex shapes, cuts with low damage, and cuts that pass through multiple layers of material.

### SUMMARY

Laser processing techniques may be used to form structures for electronic devices. Laser processing systems may have lasers and positioners for moving laser beams across a structure to be processed such as a layer of glass or other material.

A laser such as a pulsed infrared laser may be move along a path across the layer of material. Laser light from the laser may have a wavelength that allows the light to pass through the layer of material. The power density of the laser may be sufficient to induce Kerr-lens focusing in the layer of material.

The laser may create a series of damaged regions in the layer of material. The damaged regions may form a cut line along which the layer of material is cut. The layer of material may be a brittle material such as glass. During cutting, a portion of the layer may be removed from other portions of the layer by breaking off the portion of the layer along the cut line. Laser-induced heating techniques and mechanical stress-inducing techniques may be used to impart stress to the layer of material to help break off the portion. The layer may include one or more sublayers such as layers of glass substrate material in a display.

### BRIEF DESCRIPTION OF THE DRAWINGS

FIG. 1 is a perspective view of an illustrative electronic device of the type that may be provided with one or more layers of material that have been cut or otherwise processed using laser light in accordance with an embodiment.

FIG. 2 is a perspective view of an illustrative system for processing the layers of a display or other layers in accordance with an embodiment.

FIG. 3 is a cross-sectional side view of a portion of a laser processing system that can be used to form a series of laser-damaged regions along a cut line in accordance with an embodiment.

FIG. 4 is a graph in which laser intensity has been plotted as a function of time for an illustrative train of ultrafast laser pulses from a mode-locked laser in accordance with an embodiment.

FIG. 5 is a graph in which an illustrative laser intensity envelope containing a series of laser pulses has been plotted as a function of time in accordance with an embodiment in accordance with an embodiment.

FIG. 6 is a top view of an illustrative layer of material in which a series of laser damaged regions has been formed along a desired cut line in accordance with embodiment.

FIG. 7 is a top view of an illustrative mother glass layer to be cut using laser cutting techniques in accordance with an embodiment.

FIGS. 8, 9, 10, 11, and 12 are top views of illustrative laser cut layers in accordance with an embodiment.

FIG. 13 is a flow chart of illustrative steps involved in forming an electronic device with one or more laser processed layers of material in accordance with an embodiment.

### DETAILED DESCRIPTION

Electronic devices may be provided with layers of material such as glass layers and other layers of brittle and transparent material. These layers can be cut using laser processing techniques. For example, a display panel that includes glass substrate layers can be cut from a mother glass display panel using laser cutting techniques. Display cover layers, touch sensor layers, glass housing structures, and other layers of material may also be cut using laser cutting techniques.

The laser cutting techniques may involve using a laser to apply a series of high energy pulses to the material that locally damage the material. A sequence of laser-damaged spots or damaged regions of other shapes may be formed along a desired cut line through the material. The damage along the cut line weakens the layer along the cut line and allows unwanted material to be broken off from remaining portions of the layer along the cut line.

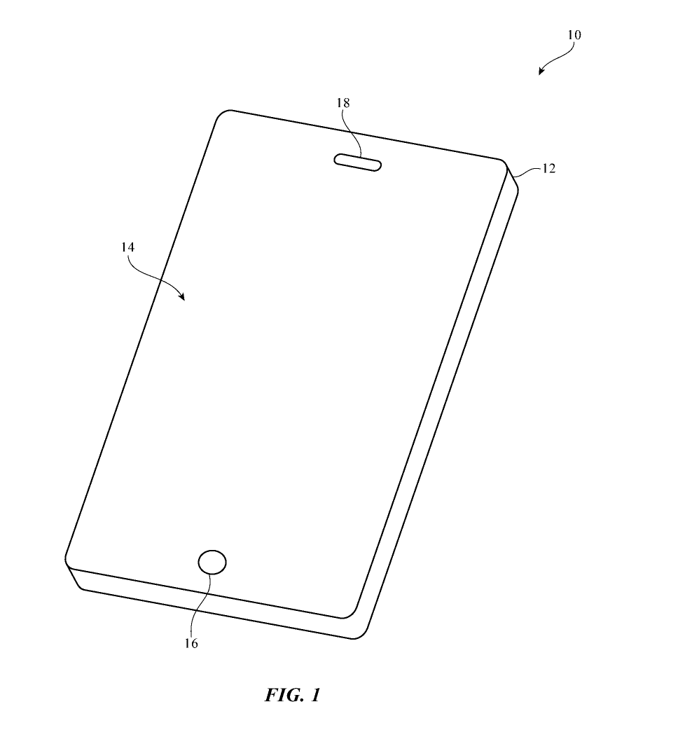

FIG. 1 is a perspective view of an illustrative electronic device of the type that may include a display or other component with one or more laser-cut edges. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, an accessory (e.g., earbuds, a remote control, a wireless trackpad, etc.), or other electronic equipment. In the illustrative configuration of FIG. 1, device 10 is a portable device such as a cellular telephone, media player, tablet computer, or other portable computing device. Other configurations may be used for device 10 if desired. The example of FIG. 1 is merely illustrative.

As shown in FIG. 1, device 10 may include display 14. Display may be mounted in housing 12. In the illustrative configuration of FIG. 1, housing 12 has a planar shape. In a laptop computer or other structure with a hinge, housing 12 may have upper and lower portions that rotate with respect to each other about the hinge. In this type of arrangement, display 14 may be mounted in the upper housing and a keyboard, trackpad, and other components may be mounted in the lower housing (as an example).

Housing 12, which may sometimes be referred to as an enclosure or case, may be formed from plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.). Openings may be formed in housing 12 to form communications ports, holes for buttons, and other structures.

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch sensor electrodes may be formed from an array of indium tin oxide pads or other transparent conductive structures.

Display 14 may have an active area that includes an array of pixels. The array of pixels may be formed from liquid crystal display (LCD) components, an array of electrophoretic pixels, an array of plasma display pixels, an array of organic light-emitting diode pixels or other light-emitting diode pixels, an array of electrowetting pixels, or pixels based on other display technologies. Illustrative configurations for display 14 in which display 14 is a liquid crystal display may sometimes be described herein as an example. This is merely an example. Display 14 may be any suitable type of display.

Display 14 may be protected using a display cover layer such as a layer of transparent glass, clear plastic, transparent ceramic, sapphire or other transparent crystalline material, or other transparent layer(s). The display cover layer may have a planar shape, a convex curved profile, a concave curved profile, a shape with planar and curved portions, a layout that includes a planar main area surrounded on one or more edges with a portion that is bent out of the plane of the planar main area, or other suitable shape. Openings may be formed in the display cover layer to accommodate button 16, speaker ports such as port 18, and other structures. If desired, the display cover layer may be omitted. For example, in a liquid crystal display with substrate layers such as a color filter layer, thin-film transistor layer, or a combined color filter and thin-film transistor layer, one or more of the substrate layers may be used as the outermost layer of display 14 in place of a display cover layer.

Display 14 may have an inactive border region that runs along one or more of the edges of the active area of display 14. The inactive area may be free of pixels for displaying images and may overlap circuitry and other internal device structures in housing 12. To block these structures from view by a user of device 10, the underside of the display cover layer or other layer in display 14 that overlaps the inactive area may be coated with an opaque masking layer.

Rigid layers of material may be used in forming display 14 and other structures in device 10 such as housing structures, touch sensor panels, windows for light-based devices such as cameras and camera flash components, button members for buttons, etc. The rigid layers of material may be glass layers, layers of sapphire or other crystalline structures, ceramic layers, or other rigid structures. These layers of material may be sufficiently transparent at laser processing wavelengths such as infrared wavelengths to allow laser light to penetrate through the layers of material, while absorbing a fraction of the laser light, which induces localized damage. To support display output operations, image capture operations, and other device functions that require the passage of light, the layers of material may also be transparent at visible wavelengths. Due to the infrared and/or visible light transmissivity of the rigid layers of material, these layers of material may sometimes be referred to as transparent rigid layers.

The transparent rigid layers may be sufficiently brittle to allow portions of the layers to be broken away from remaining portions (as when cleaving away an edge portion of a substrate following scribing operations) following laser processing. To promote the formation of high quality edges, cut lines (cleavage lines) through these layers can be formed using thin focused beams of laser light that create elongated regions of laser damage.

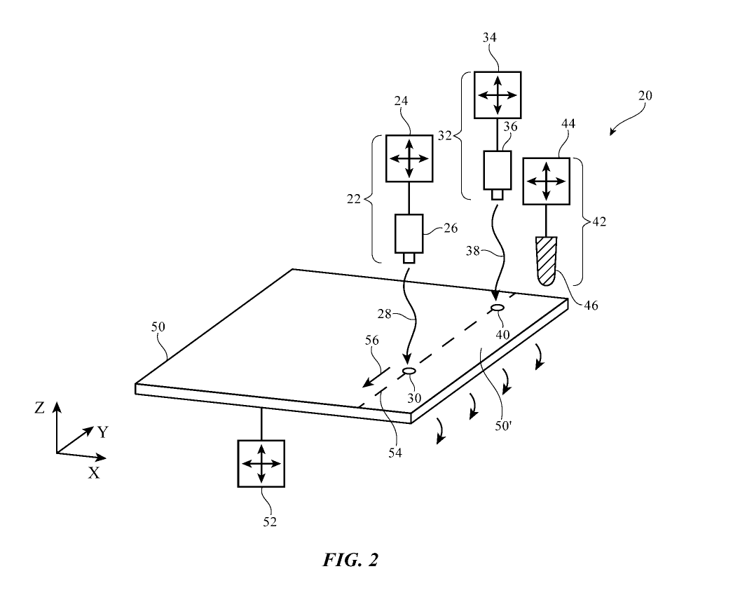

An illustrative system for producing laser-induced damage in a layer of glass or other brittle material is shown in FIG. 2. As shown in FIG. 2, laser processing system 20 may include one or more laser systems such as laser system 22 and laser system 32. Laser processing system 20 may be used to process a structure such as layer 50. Layer 50 may be a display layer or other structure in device 10 and may include one or more sublayers (e.g., glass layers, etc.). During processing, computer-controlled positioners in system 22 and 32 and/or a workpiece positioning system such as computer-controlled positioner 52 may be used to move laser beams relative to layer 50.

In the example of FIG. 2, a beam of light 28 from laser system 22 is being moved along path 54 in direction 56 to form localized damage in layer 50 along path 54. The localized damage allows portion 50′ of layer 50 to be broken off of layer 50 (i.e., path 54 may define a cut line through layer 50). If desired, localized damage may be created in solid areas of layer 50, along paths with curved shapes, or in other portions of layer 50. The use of laser system 22 to produce a straight line of laser-induced damage in FIG. 2 is merely illustrative.

Laser system 22 may include computer-controlled positioner 24 and laser 26. Laser 26 may produce a beam of laser light 28 that is focused onto layer 50 to produce laser spot 30. Layer 50 is preferably transparent at the wavelength of laser 26, which allows laser light to pass through layer 50 and thereby damage the entire thickness of layer 50 under spot 30. The material under spot 30 can be damaged in a single pass (i.e., laser beam 28 can be scanned along path 54 once). The material in the damaged region is preferably not removed by light 28 (e.g., the material is not ablated), but rather is converted by light 28 from its normal undamaged state to a damaged state (e.g., a state including voids, material with altered grain size, material with an altered molecular composition, high amounts of stress, etc.). Laser 26 may be a visible light laser, an ultraviolet light laser, or an infrared light laser and may be a pulsed or continuous wave laser. Configurations in which laser 26 is an infrared laser are sometimes described herein as an example.

After system 22 forms laser-damaged line 54 in layer 50, portion 50′ may be broken away from the rest of layer 50. With one illustrative configuration, a mechanical system such as system 42 may be used to apply force to portion 50′. System 42 may, for example, have a computer-controlled movable member such as pin 46 that can be pressed against portion 50′ using a positioning system such as computer-controlled positioner 44. If desired, laser light 38 from laser system 32 may be used to create thermally-induced stress along path 54, which may break away portion 50′ or help to weaken layer 50 along path 54 sufficiently to be broken using system 42. Laser system 32 may include a computer-controlled positioner such as positioner 34 and a laser such as laser 36 that is positioned using positioner 34. Laser 36 may produce laser light 38, which may be focused to a spot on layer 50 such as spot 40. Spot 40 may, if desired, be moved along path 54 from the edge of layer 50 to induce thermal stress along path 54. If desired, spots such as spot 40 may be applied to both the upper and lower surfaces of layer 50 (e.g., when layer 50 includes multiple sublayers). The configuration of FIG. 2 is merely illustrative. Laser 36 may be any suitable type of laser that produces stress-inducing (heat-inducing) laser light. For example, laser 36 may be a continuous wave infrared laser that produces infrared light at a wavelength of about 9-11 microns or other suitable wavelength. Laser 36 may be, for example, a carbon dioxide laser that produces laser light 38 at 9-11 microns in wavelength that is absorbed in the uppermost 10-20 microns of layer 50.

Layer 50 and the one or more sublayers of material in layer 50 may have any suitable thickness (e.g. 0.05 mm to 4 mm, more than 0.5 mm, 0.5 mm to 3 mm, 0.1 mm to 2 mm, less than 1 mm, more than 0.3 mm, or other suitable thickness). The Kerr-lens focusing effect (in which increased laser intensity induces a localized increase in refractive index that, in turn, produces enhanced focusing) and the formation of localized regions of plasma in layer 50 may affect light propagation through layer 50. These effects may, for example, help maintain light 28 in a beam shape that promotes the formation of long straight columns of damaged material.

As shown in FIG. 3, laser system 22 may include a focusing lens such as lens 60. Lens 60 may be a Bessel beam optical system (Bessel optics) that focuses the laser light 28 that is exiting laser 26 into a beam (e.g. a beam at spot 30) that has a Bessel function intensity profile (e.g., the intensity of light at spot 30 may be represented by Bessel function Jₒ). The power density of beam 28 may be 2.4 GW/cm², may be 1-5 GW/cm², may be 0.25-25 GW/cm², may be greater than 0.5 GW/cm², may be less than 10 GW/cm², or may be any other value suitable for causing a desired type of damage to layer 50. When beam 28 is provided with a Bessel function intensity profile and sufficient intensity, beam 28 will propagate through layer 50 while being focused and defocused by effects such as Kerr-lens focusing and plasma defocusing. Laser beam 28 may be pulsed so that a series of separate vertically oriented damaged regions 70 may be formed in layer 50 as laser 26 and beam 28 are scanned across layer 50 in direction 56. The speed at which beam 28 is translated across the surface of layer 50 may be, for example, 1000 mm per minute, more than 500 mm per minute, less than 2000 mm per minute, or other suitable speed.

Damaged regions 70 are formed in layer 50 as beam 28 passes through layer 50. Damaged regions 70 may have high aspect ratios. For example, the width of each damage region 70 may be about 1-2 microns, more than 3 microns, less than 20 microns, or other suitable width, whereas the length of each damaged region 70 may be 10-500 microns, 100-1000 microns, more than 200 microns, less than 3000 microns, or other suitable length. High-aspect-ratio elongated damaged regions 70 (e.g., regions with aspect ratios of five or more, ten or more, 25 or more, etc. may sometimes be referred to as column-shaped damaged regions or elongated damaged regions (e.g., regions that are elongated parallel to surface normal n of layer 50). In Kerr-lens focusing regions 74, beam 28 is focused via Kerr-lens focusing effects. At high light intensities, regions of plasma 72 may be formed that tend to spread beam 28. As beam intensity drops off, Kerr-lens focusing again focuses beam 28. As shown in FIG. 3, this results in a narrow and straight profile for each elongated damaged region 70 that is characterized by alternating expanding and contacting portions.

Illustrative layer 50 of FIG. 3 has sublayers 50-1 and 50-2. With one illustrative configuration, display 14 may be a liquid crystal display and sealant 68 may be used to retain a layer of liquid crystal material in gap 62 between layers 50-1 and 50-2. Gap 62 may be 1-150 microns thick, may be 5-75 microns thick, may be 40-120 microns thick, may be less than 100 microns thick, may be more than 0.5 microns thick, or may have any other suitable size. Light 28 may pass through gap 62, which allows multiple layers to be cut.

Layer 50-1 may be a thin-film transistor layer having a layer of thin-film transistor circuitry 66 on a glass layer. Thin-film transistor circuitry 66 may form pixel electrodes and associated pixel control circuits for a liquid crystal display. Layer 50-2 may be a color filter layer having an array of color filter elements 64 on a transparent layer such as a glass layer to provide display 14 with the ability to display color images. If desired, layer 50-1 may be a color filter layer and layer 50-2 may be a thin-film transistor layer. Configurations in which color filter layer structures and thin-film transistor circuitry are formed on a common substrate may also be used in forming display 14. Other layers may be used in forming a display such as display 14 if desired (e.g., clear substrate layers, glass layers to provide support and/or protection in organic light-emitting diode displays and other displays with light-emitting diodes, a display cover layer, etc.). The arrangement of FIG. 3 is shown as an example.

Laser 26 may be a mode locked Nd:YAG laser or other suitable laser. Beam 28 may have a wavelength of 1064 nm, a wavelength of 1-2 microns, or other suitable wavelength (e.g., a near infrared wavelength). At these wavelengths, layer 50 is transparent, which allows beam 28 to propagate through layer 50 and form elongated damaged regions 70.

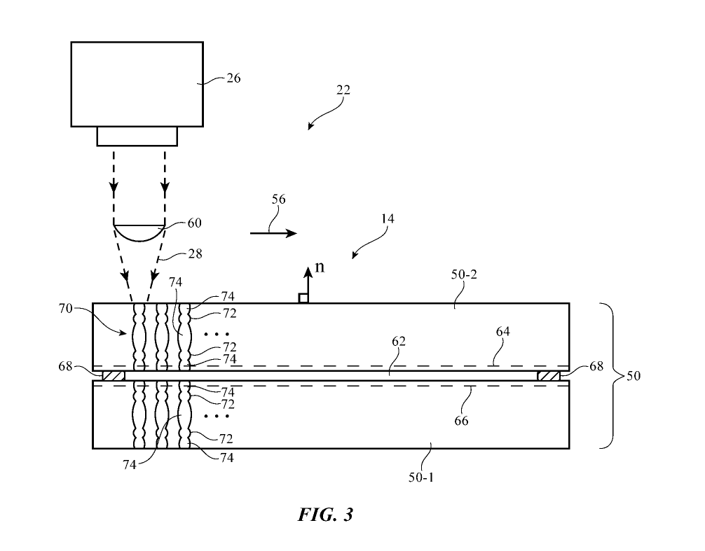

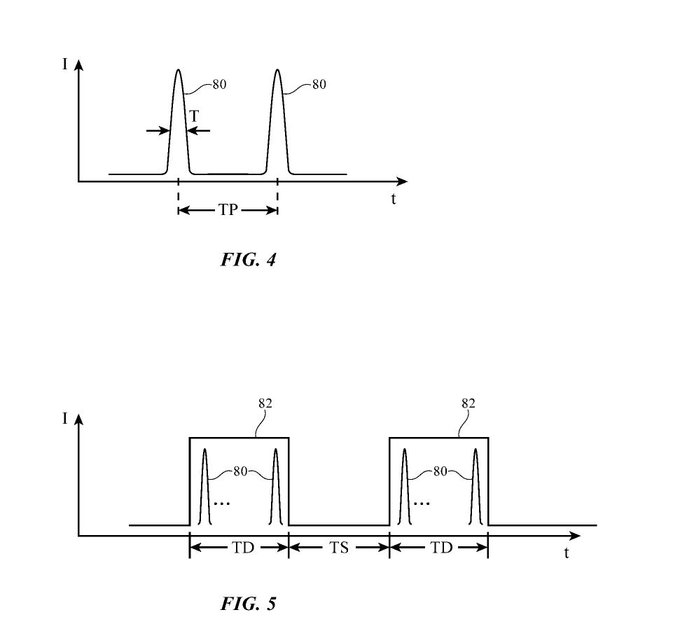

Laser 26 may be mode locked at a frequency of about 100-200 kHz (as an example). The mode locking operation of laser 26 produces a train of ultrafast pulses (e.g., pulses of tens of picoseconds in duration or less) with high peak intensities. The train of mode locked pulses may be modulated using a pulse envelope. FIG. 4 is a graph of an illustrative train of mode locked ultrafast pulses. FIG. 5 is a graph of an illustrative modulation envelope that may be used for the pulse train.

As shown in the graph of FIG. 4, laser 26 may produce a train of ultrafast pulses 80. The duration of each of ultrafast pulses 80 may be about 10 ps full-width half-maximum (e.g., 5-15 ps, more than 3 ps, less than 50 ps, etc.). Pulses 80 may repeat with a period TP. The value of TP may be 14-36 ns, may be less than 20 ns, may be less than 40 ns, may be more than 5 ns, more than 25 ns, or may be any other suitable duration.

The train of ultrafast pulses of FIG. 4 may be modulated to form laser beam intensity pulses 82 of FIG. 5. Each pulse 82 may contain one or more ultrafast pulses 80 from the train of ultrafast pulses produced by the mode locking system of laser 26. For example, each pulse 82 may contain 2-14 pulses 80, may contain 6-10 pulses 80, may contain more than one pulse 80 may contain more than 3 pulses, may contain fewer than 20 pulses, or may contain any other suitable number of mode locked pulses 80.

Each damaged region 70 may be produced using one or more of pulses 82. After a given damaged region 70 has been produced, laser 26 may be moved along path 54 so that another damaged region 70 may be produced using another set of one or more of pulses 82. With one illustrative configuration, laser 26 is moved continuously and each of pulses 82 produces a corresponding one of damaged regions 70. The duration TD of each of laser pulses 82 and the off period TS between respective pulses 82 may be about 20-400 ns, more than 10 ns, more than 50 ns, more than 100 ns, less than 1000 ns, less than 500 ns, less than 250 ns, or other suitable value. TD may be greater than TS, may be the same as TS, or may be less than TS.

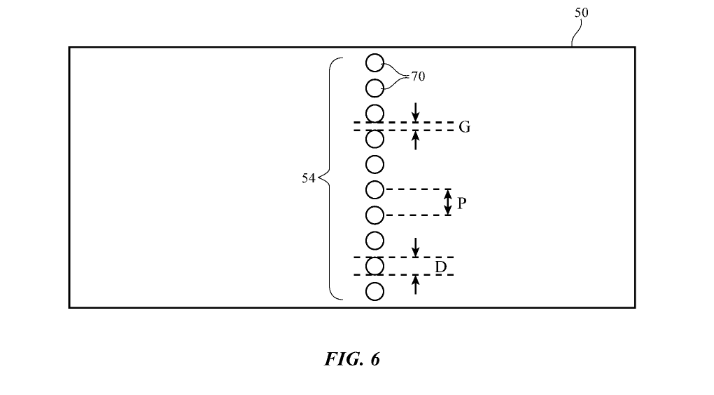

As laser beam 28 is pulsed to produce pulses 82 and is moved along path 54, a series of damaged regions 70 may be produced through layer 50. As shown in the top view of layer 50 of FIG. 6, each damaged region 70 may have a diameter G. Diameter G may be about 1-2 microns, more than 3 microns, less than 20 microns, or other suitable diameter. The center-to-center spacing of damaged regions 70 (i.e., pitch P) may be about 2-7 microns, 3-6 microns, more than 1 micron, more than 2 microns, more than 3 microns, more than 10 microns, less than 20 microns, less than 15 microns, less than 7 microns, or other suitable value. The gap size G between the edges of a pair of adjacent damaged regions 70 may be about 1.3 microns, more than 1 micron, more than 2 microns, less than 3 microns, less than 2 microns, or other suitable size.

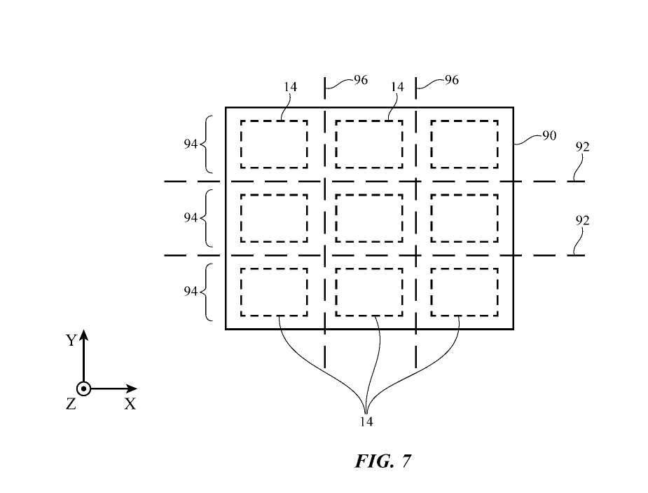

Displays 14 for electronic devices 10 may be formed from large mother glass display panels such as mother glass display panel 90 of FIG. 7. Laser processing system 20 may be used to cut panel 90 along lines such as lines 92 and 96. For example, panel 90 may first be cut along lines 92 to form strips 94 of mother glass 90 each of which contains multiple display panels 14. After forming strips 94, laser cuts may be formed along lines 96 (i.e., strips 94 may be divided up into individual displays 14). Display edges may be finished using grinding operations and other finishing operations after laser cutting. Illustrative layer 50 of FIG. 3 has a pair of layers (50-1 and 50-2) that are cut simultaneously (i.e., damaged regions 70 each pass through both of layers 50-1 and 50-2). If desired, three or more layers of material, stacked structures with four or more layers, or other multilayer structures may be cut and/or laser processing system 20 may be used to process structures that are not part of the layers of display 14. The cutting of a mother glass panel such as panel 90 of FIG. 7 (e.g., a panel having upper and lower glass layers for a liquid crystal display configuration) is merely illustrative.

In configurations with multiple layers of material, it is not necessary for all of the layers of material to be transparent to laser light 28, so long as the upper layers of material are transparent. Layer 50 is preferably transparent at the wavelength of laser light 28 (e.g., layer 50 is preferably infrared transparent when laser 26 is an infrared laser) so that damaged regions 70 can propagate straight through layer 50 rather than being absorbed on the surface of layer 50. Laser system 20 may be used to cut brittle materials such as glass or other suitable materials (e.g., infrared transparent coatings, etc.). If desired, system 20 may be used to form complex features in structures such as layer 50 (e.g., edge chamfering, recessed portions that do not pass entirely through layer 50, etc.). The use of system 20 to cut vertically through a planar layer of glass is merely illustrative.

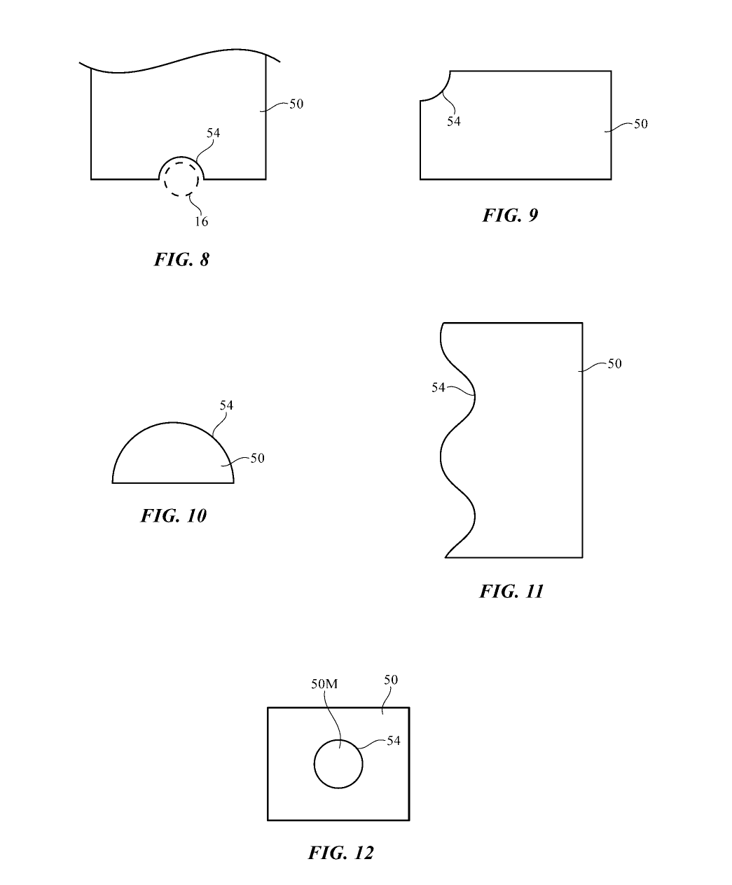

System 22 may cut layer 50 along paths 54 that are curved or that include curved and straight portions. Illustrative shapes for path 54 are shown in FIGS. 8, 9, 10, 11, and 12.

In the example of FIG. 8, layer 50 (e.g., a layer for a display in a cellular telephone, etc.) may be cut along a path 54 that includes a recessed portion (e.g., a semicircular recess) to accommodate a round structure such as button 16. FIG. 9 shows how a curved portion of path 54 may be used to remove a curved corner region from layer 50. In the configuration of FIG. 10, layer 50 has been cut into a semicircular shape. Path 54 has a curved semicircular portion that defines a peripheral edge of the semicircular shape. A meandering cut path is shown in FIG. 11. Paths such as path 54 of FIG. 11 may have one or more recessed portions and one or more protruding portions. Paths with protrusions and/or recesses may be used to accommodate electrical components in device 10 (e.g., to form openings for cameras, sensors, buttons, and other input-output devices).

If desired, system 22 may cut away enclosed portions of layer 50 (e.g., to form an opening for button 16 of FIG. 1, speaker port 18 of FIG. 1, an opening for a camera window, etc.). As shown FIG. 12, for example, path 54 may be circular. When path 54 is circular, path 54 encloses inner portion 50M of layer 50 and allows inner portion 50M to be removed from the rest of layer 50 to form an opening in layer 50. Openings of any suitable shape may be formed in layer 50 using this approach (e.g., rectangular openings, openings with rounded corners and straight sides, openings with combinations of curved and straight sides, etc.). The illustrative circular opening arrangement of FIG. 12 is merely illustrative.

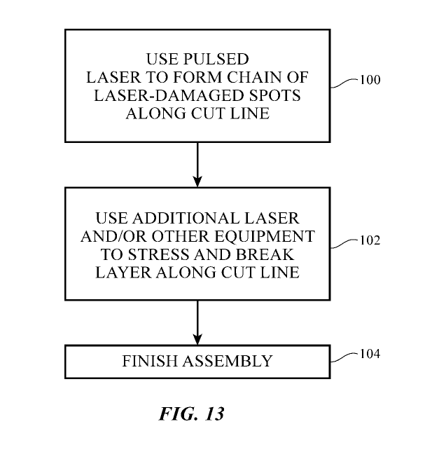

A flow chart of steps involved in forming an electronic device having structures that are processed using laser processing system 20 is shown in FIG. 13. System 20 may be operated using computer control and/or manual control.

At step 100, laser 26 of system 22 is used to apply a series of pulses (i.e., pulses 82 of FIG. 5) to layer 50 while laser 26 is moved along path 54 by positioner 24 (and, if desired, positioner 52). This creates a set of laser-damaged regions such as elongated damaged regions 70 of FIGS. 3 and 6. The damaged regions may have elongated shapes with high aspect ratios (e.g., ratios of depth to width greater than 10, greater than 5, greater than 20, 2-40, 3-15, less than 75, etc.). The elongated damaged regions may extend along the axis of beam 28. Damaged regions 70 may overlap or, more preferably, may be discrete regions of damage that form a series of separate spots along the surface of layer 50. The path along which the chain of damaged regions 70 is formed may serve as a cut line through layer 50.

At step 102, layer 50 may be stressed along line 54. For example, laser system 32 may produce light 38 that heats the surface of layer 50 and/or the entire thickness of layer 50 along path 54. System 32 may, for example, scan laser beam 38 along the same path (path 54) that was followed by beam 28 when creating damaged regions 70. The heated portions of layer 50 may create stress (e.g., thermal stress) that spontaneously cracks layer 50 along path 54 or that at least helps to weaken layer 50 along path 54. With one suitable arrangement, portion 50′ of layer 50 is cracked off of the rest of layer 50 using a thermal stress propagation cracking process in which laser beam 38 is moved along path 54 starting from the edge of layer 50. Laser beam 38 may be an infrared laser beam such as a carbon dioxide layer beam at 9-11 microns in wavelength that is absorbed in the first 5-20 microns of the surface of layer 50 or other suitable laser beam. If desired, stress can be imparted to layer 50 using mechanical system 42 (e.g., member 46 may press down on edge portion 50′ of layer 50 in the example of FIG. 2 to help break of portion 50′ from the remainder of layer 50). Mechanical system 42 may be used in combination with system 32 or in the absence of system 32 (i.e., system 42 may be the sole source of breaking stress imparted to layer 50 such as when punching out a portion of an enclosed circular region of layer 50 such as region 50M of FIG. 12, etc.).

At step 104, after undesired portions of layer 50 such as layer portion 50′ of FIG. 2 and layer portion 50M of FIG. 12 have been removed from layer 50, layer 50 may be used to form a finished component (e.g., edge portions of layer 50 may be polished using a grinding wheel and other finishing equipment, electrical components and other structures may be mounted on a portion of layer 50, etc.). The finished component(s) formed from layer 50 (e.g., a display or other structure) and additional device components (e.g., circuits, sensors, input-output components, etc.) may be assembled to form a completed electronic device 10.

The foregoing is merely illustrative and various modifications can be made by those skilled in the art without departing from the scope and spirit of the described embodiments. The foregoing embodiments may be implemented individually or in any combination.

What is claimed is:

1. A method of cutting a layer of material, comprising:
moving a pulsed laser beam along a path across the layer of material to create a series of laser-damaged regions that each pass through the layer of material; and
breaking away a portion of the layer of material along the path.

2. The method defined in claim 1 further comprising:
producing the pulsed laser beam using an infrared laser.

3. The method defined in claim 2 wherein producing the pulsed laser beam comprises modulating a train of ultrafast pulses from a mode locked laser to form the pulsed laser beam.

4. The method defined in claim 1 wherein the layer of material comprises a layer of glass and wherein moving the pulsed laser beam comprises creating the series of laser-damaged regions through the glass with the pulsed laser beam by Kerr-lens focusing and plasma defocusing.

5. The method defined in claim 1 wherein breaking away the portion of the layer comprises applying heat to the path.

6. The method defined in claim 5 wherein applying heat to the path comprises applying laser light to the path.

7. The method defined in claim 6 wherein applying laser light to the path comprises scanning laser light along the path after forming the series of laser-damaged regions.

8. The method defined in claim 7 wherein applying the laser light comprises applying laser light with a wavelength of 9-11 microns.

9. The method defined in claim 8 wherein moving the pulsed laser beam comprises moving a near-infrared pulsed laser beam.

10. The method defined in claim 9 wherein the layer comprises at least one glass layer and wherein breaking away the portion comprises cracking the glass layer.

10. The method defined in claim 1 wherein the layer comprises at least two glass display layers and wherein breaking away the portion comprises cracking the two glass display layers.

11. The method defined in claim 1 wherein the layer comprises at least one glass layer and wherein moving the pulsed laser beam comprises moving a pulsed laser beam along the path that has power density of 0.25-25 GW/cm².

12. The method defined in claim 1 wherein at least a portion of the path is curved and wherein scanning the pulsed laser beam comprises scanning the pulsed laser beam along the curved portion.

13. The method defined in claim 12 wherein breaking away the portion comprises applying stress to the portion with a computer-controlled movable member.

14. A method of forming a display, comprising:
attaching a first substrate layer to a second substrate layer; and
cutting through the first and second attached substrate layers using at least one moving laser beam.

15. The method defined in claim 14 wherein cutting through the first and second attached substrate layers with the moving laser beam comprises cutting through the first and second attached substrate layers by moving an infrared laser beam across the first and second attached substrate layers that passes through the first and second attached substrate layers.

16. The method defined in claim 15 wherein the first and second attached substrate layers comprise first and second attached glass layers and wherein cutting through the first and second attached substrate layers comprises moving the laser beam along a path across the first and second attached glass layers.

17. The method defined in claim 16 wherein moving the laser beam comprises moving a pulsed infrared laser beam along the path to create a series of discrete laser-damaged regions through the first and second attached substrate layers.

18. The method defined in claim 17 wherein cutting through the first and second attached substrate layers comprises applying stress to the series of discrete laser-damaged regions to break a first portion of the first and second attached substrate layers away from a second portion of the first and second attached substrate layers.

19. The method defined in claim 18 wherein applying the stress comprises scanning a laser beam over the series of discrete laser-damaged regions to generate thermal stress.

20. A display, comprising:
a first glass substrate layer; and
a second glass substrate layer that is separated from the first glass substrate layer by a gap, wherein the first and second glass substrate layers have an edge with a series of discrete laser-damaged regions.
